(19) United States
(12) Patent Application Publication
(10) Pub. No.: US 2003/0183754 A1
(43) Pub. Date: Oct. 2, 2003

(54) Method for counting photons in laser-scanning systems

(76) Inventors: Ralf Wolleschensky, Schoeten (DE); Gunter Moehler, Jena (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/381,090

(22) PCT Filed: Mar. 5, 2002
(86) PCT No.: PCT/EP02/02375

(51) Int. Cl. H01J 3/14

(52) U.S. Cl. 250/234

(57) ABSTRACT

Method for photon counting in the detection channel of a laser scanning arrangement, preferably a laser scanning microscope, wherein the amplitude of the incoming photons is determined by means of a plurality of threshold values and the determination of thresholds is coupled with a time-resolved measurement in that pulse counting is carried out respectively for individual threshold values and the sum of the counted pulses is determined for the threshold values, wherein when a higher threshold value is reached, the counting value of the low threshold value is stored for the counting.

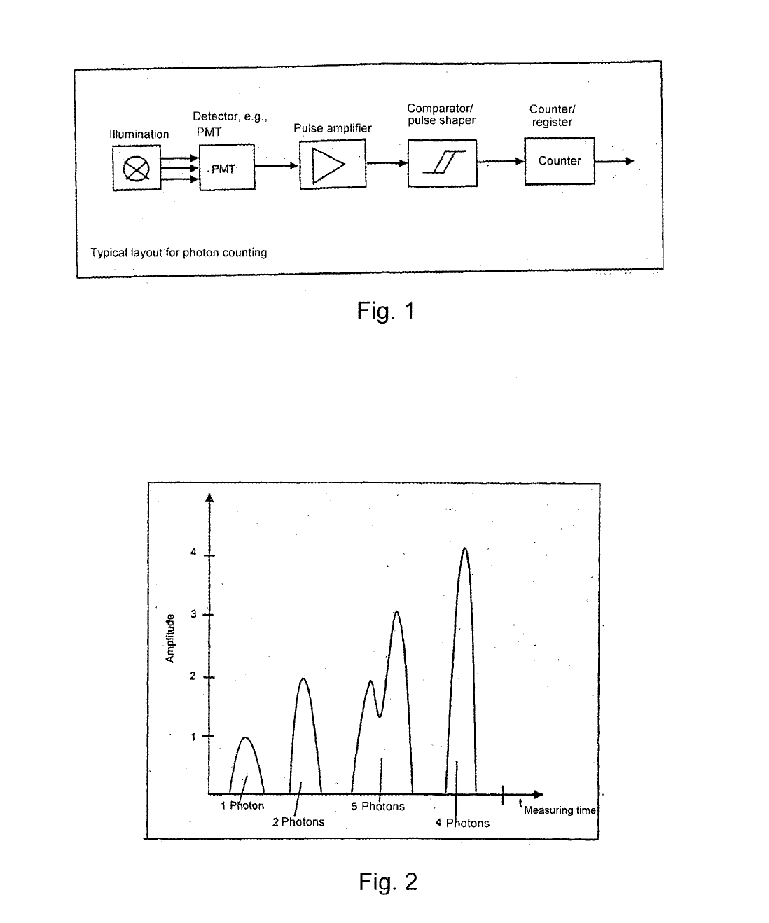

It is already known in connection with laser scanning microscopes that photons detected by a PMT can be resolved individually by counting the photons by means of pulse amplifiers and threshold switches such as comparators which are arranged following a PMT (FIG. 1).

FIG. 2 shows typical examples of how faulty measurements can occur.

Overlapping photons have the same width but a greater amplitude. Only individual photons of a fixed amplitude can be counted in solutions utilizing a comparator/discriminator. A photon is detected once the adjusted threshold has been exceeded. When two photons occur at the same point in time, the amplitude is increased, but the switching threshold is also exceeded only once and is therefore counted once. Neighboring photons (photons not resolvable in spacing) are wider than one photon but have the same amplitude.

The comparator requires a certain (switching time) in order to pass from one state to the other. When the individual photons are so close together that the comparator can not detect the level changes of the adjacent photons with its switching time, it will detect only one state and accordingly only one photon.

This is shown schematically in FIG. 2 by the example of two simultaneously occurring photons which are counted as one, and five photons where two successive photons come very close behind three photons and therefore act as only one photon for the comparator.

In a possible variant in which the photon time is used as a gate time for a frequency measurement, the photons flowing into one another are detected exactly, but not the photons lying on top of one another, in which case inaccuracies persist.

Solution According to the Invention

Arriving photons are evaluated two-dimensionally in that the amplitude is measured in a plurality of threshold values and the measurement is carried out in a time slot pattern. Pulses of a higher frequency than that predetermined by the photon time are counted with a counting frequency of at least twice the photon time (empirical duration of the required measurement for one photon).

The summing of amplitude and time measurements then forms the actual photon count ZP.

Comparators, discriminators, triggers and, in digital form, AD converters and associated registers can be used, for example, for threshold determination.

The photon time can be used as gate time for time-resolved determination, during which time a still higher frequency runs in the counter.

The results can be combined in a counter or in an adder and can be read out by a register. The register is reset by a clear pulse after every measurement.

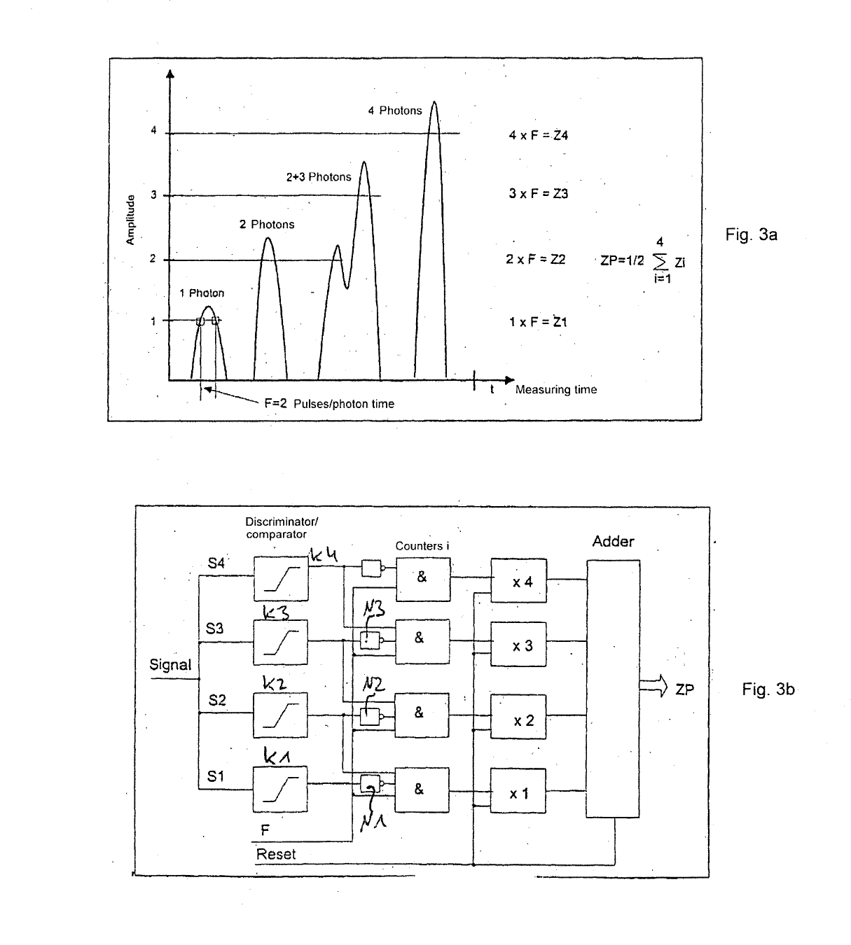

The principle of two-dimensional detection of photons according to the invention will be described in the following with reference to FIGS. 3a) and b).

The signal to be measured is applied to the inputs of the four comparators simultaneously. When the input signal exceeds the threshold switch S1, the comparator changes state and releases the gate circuit (NOT element and AND operation).

If the input signal has the length of only one photon time, two pulses (the counting frequency is selected in such a way that two pulses are counted during the time period for one photon) run through the AND operation in counter 1 (x1). When the switching threshold S2 is reached during the measuring time (pixel time of an LSM, dwell time for the detection of a pixel) and the pulse width of the comparator has the width of only one photon time, two pulses also run into counter 2 via line F, N2 and the AND element.

This formulation F=2 pulses means that at least two pulses must be counted per photon time based on the sampling theorem. The determination of the total photon number then has the factor of ½ in the sum formula. This results from the determination of at least two pulses per photon. If there were ten-times this counting frequency, the factor 1/10 would have to be present in the sum formula in order to arrive at the actual photon number. When comparator S2 has reached the threshold, the AND operation of the first comparator is immediately blocked with the output of the comparator and that of the second comparator is opened. The subsequent switching of the second comparator is compensated by the running or transit time of the signal of the first comparator through the first NOT element N1, so that the second comparator can still reliably block the first gate circuit. The pulses in counter 2 are multiplied by 2 (2×F), the pulses in counter 3 are multiplied by 3 (3×F), and so on, and accordingly obtain a higher value than pulses running into counter 1 via comparator one. The second dimension is accordingly measured because photons coming one behind the other generate only a higher amplitude, but can have the same duration.

The switching thresholds S2 and S4 behave in the same way. Every time a higher switching threshold responds, the counting channels below it are blocked, and the additional NOT elements N2, N3 . . . provide for a corresponding compensation of transit time as is the case with the first NOT element, so that the second or additional gate circuits can still be blocked.

The highest respective threshold has priority. After the measuring time expires, the counting values Z of the counters i are combined (summed) by an adder and, e.g., placed in a register as measurement value ZP and subsequently read by a computer and further processed. With pulses which only respond to comparator one but which last longer than one photon time, a correspondingly higher number of pulses run into the counter X1 via line F, the AND operation. Photons blending into one another or tightly spaced photons are accordingly detected, correctly counted and interpreted.

The connection of amplitude monitoring and time measurement of the arriving photons represents an accurate image of the actual quantity of photons occurring within a measurement time.

The following is achieved by means of improved accuracy:

different amplitudes of the photon stream are evaluated by multistage comparators;

photons joined together by time measurement can be separated;

the results from the amplitude measurement and time measurement gives the accurate photon count.

1. Method for photon counting in the detection channel of a laser scanning arrangement, preferably a laser scanning microscope, wherein the amplitude of the incoming photons is determined by means of a plurality of threshold values and the determination of thresholds is coupled with a time-resolved measurement in that pulse counting is carried out respectively for individual threshold values and the sum of the counted pulses is determined for the threshold values.

2. Method according to claim 1, wherein when a higher threshold value is reached, the counting value of the low threshold value is stored for the counting.
